(19) United States
(12) Patent Application Publication
(10) Pub. No.: US 2001/0022627 A1
(43) Pub. Date: Sep. 20, 2001

(54) Video surveillance apparatus with a dome camera and a protective housing

(76) Inventor: Rainer Bernhardt, Rosbach vor der Hohe (DE)

Correspondence Address: FULBRIGHT & JAWORSKI, LLP, 666 FIFTH AVE, NEW YORK, NY, 10103-3198, US

(21) Appl. No.: 09/768,752

(22) Filed: Jan. 24, 2001

(30) Foreign Application Priority Data
Mar. 20, 2000 (DE) 100 13 780.6-31

(51) Int. Cl. H04N 7/18; H04N 5/225

(52) U.S. Cl. 348/373; 348/143

(57) ABSTRACT

In a video surveillance apparatus having

a) a dome camera (14) with a housing (15) and a first dome (16) in which a video camera with a lens (18) is disposed which is adjustable about a vertical axis of rotation (A-A) and a horizontal swiveling axis, having

b) a plate system (6) with electrical components and a mounting for the dome camera (14), a first plane of separation (E1-E1) being disposed between the plate system (6) and the dome camera (14), and having

c) a protective housing (19) which surrounds the plate system (6) and the dome camera (14) and which has a second dome (21) near the first dome (16),

to improve the accessibility of electrical parts and components, retrofitting, the making and breaking of mechanical and electrical connections such as screw, plug and soldered connections, the design is configured such that

d) the plate system (6) is disposed on the bottom of a supporting flange (3) and underneath its outer margin, and that

e) the second dome (21) is prolonged upward in the direction of the axis of rotation (A-A) by a housing jacket (20) which surrounds the plate system (6) and has an upper margin which is releasably connected to the supporting flange (3), a second plane of separation (E2-E2) being formed which lies above the first plane of separation.

### BACKGROUND AND SUMMARY OF THE INVENTION

The invention relates to a video surveillance apparatus having

a) a dome camera with a housing and a first dome which is at least partially permeable to radiation, in which a video camera with a lens is disposed whose optical axis is adjustable about a vertical axis of rotation and a horizontal swivel axis, with

b) a plate system with electrical components and a mounting for the dome camera, a first plane of separation being disposed between the plate system and the dome camera, and having

c) a protective housing which surrounds the plate system and the dome camera, and which has a second radiation-permeable dome in the area of the first dome.

These dome cameras and those described below are series products of several manufacturers. In approximately cylindrical housing, conductors and electronic components are disposed for a video camera whose optical axis—the axis of the lens—can rotate and swivel about a vertical axis and a horizontal axis such that, through the superimposition of the movements, all space coordinates below the housing can be reached by the optical axis of the camera lens. The swiveling range of the camera lens can be surrounded by an approximately hemispherical dome which is at least partially permeable to visible light and/or infrared radiation, and which gives the camera its name. The outside diameters of the housing and dome are approximately equal. Adjustment of the optical axis and of the angle of view can be performed manually. Also possible, however, is a remote control of the position in space of the optical axis and the angle of view of a zoom lens, and even to achieve following action by automatic target tracking. For this purpose, electric motors and their control elements for the video camera are disposed in the housing.

For certain applications, e.g., outdoors, such dome cameras can be contained in a protective housing which does not impair the operation of the dome camera and protects it against weather and acts of vandalism. Even for minimal requirements at least six electrical connections are needed, all of which must be made by hand, and this can also be done by plug connections.

In a prospectus of VIDEOLARM/USA dated 1996 it is known to compose a protective housing for a dome camera of a video surveillance apparatus of two hemispherical shells of different size, which are joined and sealed downwardly by a wide ring at their equatorial planes. The inside diameter of this ring and of the lower, transparent hemispherical shell is, however, more than twice as large as the outside diameter of the dome camera, whose housing extends far upward into the upper hemispherical shell. This difference in diameter is necessary so as to enable an installer, after removing the lower shell, to reach with his fingers and tools through the broad annular gap into the upper hemispherical shell where the electrical and mechanical connections for the dome camera are located. The result is an outside diameter of the upper hemispherical shell of about 46 centimeters, which has to be fastened in a fork-like holder of corresponding size.

Similar systems, in which difficult manipulations from underneath are necessary between the dome camera and a bulky protective housing to install and remove them, are also offered in prospectuses of VICON Industries Ltd. in Great Britain.

Through a prospectus of Sensormatic Electronics Corporation from 1998 it is known to provide the housing of a dome camera on the upper side with an expensive bayonet socket and a plurality of sliding electric contacts which are inserted into a compatible socket of a protective housing. Then a second transparent dome—also called a “bubble”—is fastened to the bottom of the protective housing. Thus does eliminate manipulations in the annular space between the dome camera and the protective housing, but this solution requires an especially adapted, compatible and expensive protective housing which is still substantially larger than the dome camera itself and cannot be used everywhere.

U.S. Pat. No. 3,819,856 discloses a protective housing for video surveillance apparatus, in which a transparent hemispherical shell is hung with a hinge on the bottom end of a truncoconical base housing, namely at about the equatorial plane of the hemisphere, whose diameter corresponds to the smaller base surface of the truncated cone. The base housing is affixed at its larger base surface to a supporting disk which serves for mounting the apparatus on the ceiling. The arrangement of plates for the wiring of the multi-conductor feeder cable coming out of the ceiling, and the details of this wiring, are not disclosed. The ceiling mounting, and the connecting and disconnecting the wiring are possible only if the apparatus is taken apart and the camera removed. On account of the narrow annular gap between the rotatable camera holder and the base housing in the said equatorial plane, mounting on the ceiling, the connection and disconnection of the wiring with the camera installed would be difficult to perform. The truncoconical skirt of the base housing cannot be separated from the supporting disk.

EP 0 642 053 A1 discloses protective housings for video surveillance apparatus, which consist of an opaque upper hemispherical shell for fastening to the ceiling and of a transparent lower dome which is barely hemispherical in shape. The fastening is performed in the equatorial plane of the upper hemispherical shell. To provide for establishing a circulation of heating air, the upper hemispherical shell contains two additional concentric spherical shell segments which along with an approximately U-shaped camera holder have to be mounted in the upper hemispherical shell after the latter is fastened to the ceiling; a plate configured as a supporting plate, which bears two blowers with heaters and a part of the multi-conductor wiring coming out of the ceiling, comes to lie between the upper hemispherical shell and the two spherical shell segments. For this kind of mounting a great number of screws are provided, which all have to be loosened and retightened whenever any change is made in the wiring, and/or an inspection is to be performed. The ceiling mounting, the wiring and the disconnection of the wiring are likewise possible only if the apparatus is taken apart and the camera removed. The only seam in the said equatorial plane is likewise much too low for lateral access to the plate when the apparatus installed. This patent also fails to deal with these problems.

The invention therefore is addressed to the problem of proposing a combination of a dome camera and a protective housing, in which no difficult manipulations are necessary, which can be manufactured cost-effectively, and in which the protective housing envelops the dome camera as closely and as sealingly as possible. In particular, conventional dome cameras of different manufacturers are to be able to be used in a protective housing which can be usable everywhere without special fitting, and are to be reliably protected against weathering and vandalism.

The solution of the stated problem is achieved by the invention in that

d) The plate system is disposed on the bottom of a supporting flange and at least substantially underneath its outer margin,

e) the second dome is prolonged upward in the direction of the axis of rotation through a housing jacket which surrounds the plate system and has an upper margin which is releasably connected to the supporting flange, a second plane of separation being formed at the junction, which lies above the first plane of separation.

The stated problem is solved in full by the invention, i.e., a combination of a dome camera and a protective housing is proposed, in which no difficult manipulations are necessary in the making and releasing of mechanical and electrical connections, which can be manufactured cost-effectively, and in which the protective housing surrounds the dome camera as closely and sealingly as possible. In particular, conventional dome cameras of different manufacturers are to be able to be inserted into a protective housing not especially adapted but universally practical and reliably protected against weathering and vandalism. When the protective housing is released and drawn downwardly, at least all important mechanical and electrical connections are fully visible and accessible for engagement of tools.

It is especially advantageous if, as a result of further embodiments of the invention—either singly or in combination:

a rotary drive and a swiveling drive are disposed in the housing for the remotely controlled movement of the optical axis of the lens;

the supporting flange has a coaxial surface onto which the upper margin of the housing jacket can be placed;

the supporting flange is of substantially disk-like configuration and joins a mounting pipe to the jacket of the protective housing;

at the bottom of the supporting flange at least one supporting plate is provided through at least one set of spacers, and on it the dome camera is fastened, the first plane of separation being between the supporting plate and the dome camera;

between the supporting flange and the supporting plate an intermediate plate is disposed, the intermediate plate being connected to the supporting flange by a first set of spacers and the supporting plate being connected to the intermediate plate by a second set of spacers;

the plate system is removably fastened as a component group on the supporting flange;

the plate system is fastened to the spacers of the supporting flange through key-hole shaped holes;

a heating element is disposed on the supporting flange and a blower on the intermediate plate for the circulation of the heated internal atmosphere of the protective housing;

a heating element is disposed on the supporting flange and a blower on the supporting plate for the circulation of the heated internal atmosphere of the protective housing;

the housing jacket has a ring on its bottom and, if the second dome has an outwardly turned margin which is affixed by a snap ring against the ring with the interposition of a gasket;

the housing jacket is surrounded by an additional jacket;

an upwardly removable protective roof is disposed above the supporting flange and its outer margin overlaps the upper margin of the protective housing;

the housing jacket of the protective housing is configured as a hollow cylinder;

the length of the housing jacket amounts to at least 0.5 times, especially 0.8 times its outside diameter;

the outer dome consists of a partially spherical shell from the margin of which a hollow cylindrical extension of the same diameter as that of the margin reaches toward the housing jacket and/or if

the outer dome consists of a hemispherical shell and a hollow cylindrical prolongation of the same diameter;

Additional a advantages re given in the following detailed description.

Two embodiments of the invention and their parts are explained below with the aid of FIGS. 1 to 12.

### BRIEF DESCRIPTION OF THE FIGURES

FIG. 1 is a partial axial section through a first embodiment of a complete video camera system with a dome camera, a plate system and a protective housing;

FIG. 2 is an exploded view of the subject of FIG. 1 with the protective roof raised and the protective housing removed;

FIG. 3 the separated protective housing of FIG. 1;

FIG. 4 a reduced axial section through the supporting flange with installation parts;

FIG. 5 a bottom view of the subject of FIG. 4;

FIG. 6 a bottom view of the heating element in FIGS. 4 and 5;

FIG. 7 a bottom view of another connecting plate in FIGS. 4 and 5;

FIG. 8 an axial section taken through an assembly of the supporting flange and the intermediate plate;

FIG. 9 a plan view of the intermediate plate of FIG. 8;

FIG. 10 an axial section of a removable component group of the intermediate plate and the supporting plate with the power transformer and an additional terminal plate;

FIG. 11 a top plan view of the supporting plate of FIG. 10; and

FIG. 12 a partial axial section through a second embodiment of a complete video camera system with a dome camera, a plate system and a protective housing, similar to FIG. 1.

### DETAILED DESCRIPTION

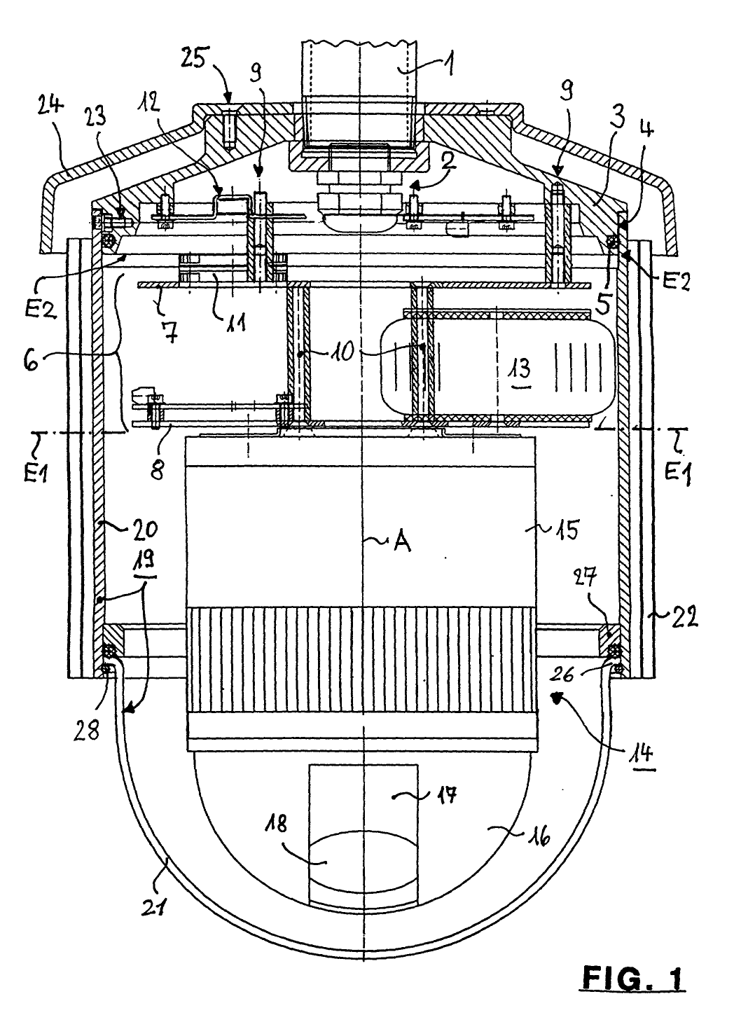

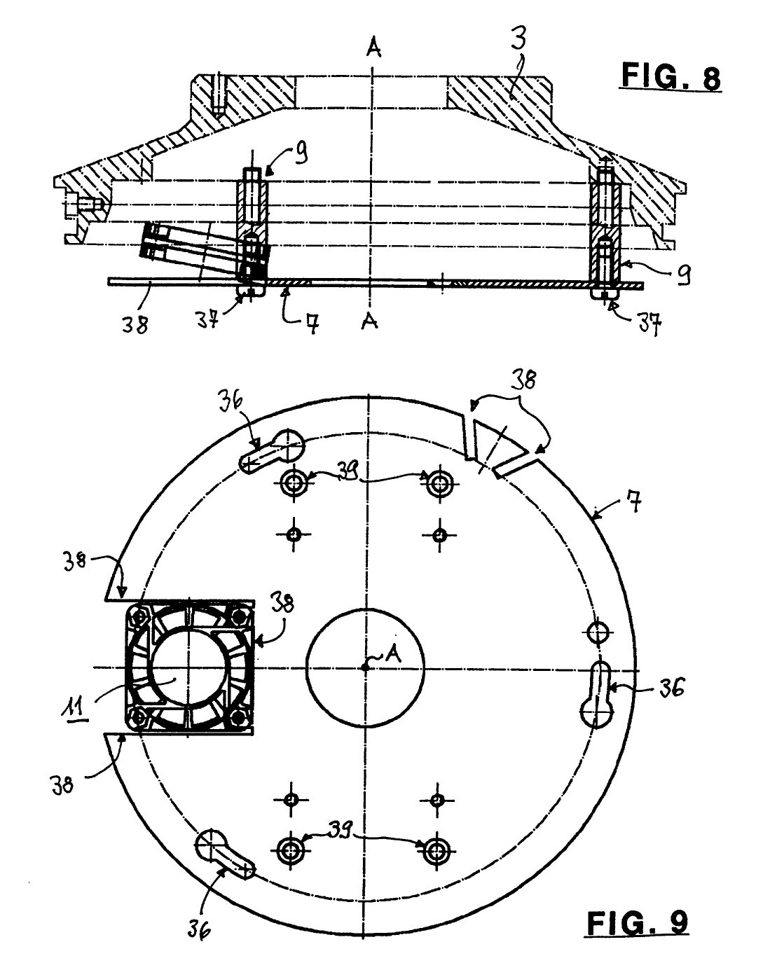

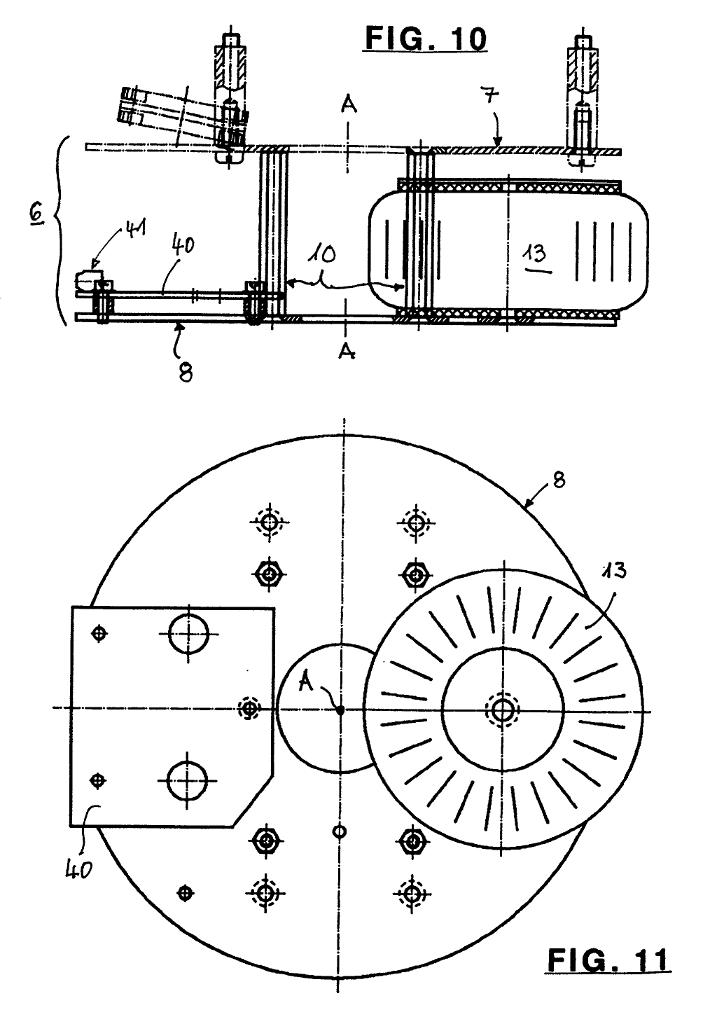

In FIG. 1 the bottom end of a mounting pipe 1 is shown, through which all the electrical conductors are brought for the power supply, the controls and the video signals, and which in the rest of its length can be either rectilinear, e.g., for ceiling mounting, or bent, e.g., for wall mounting. Also included is fastening to any other surfaces or holding devices. A PG screw thread 2 (PG=Panzer-Gewinde=armor thread) serves to bring in the wiring. The mounting pipe 1 carries on its bottom end a supporting flange 3 with an outer cylindrical surface 4 which is interrupted by a groove with an annular gasket 5. A plate system 6 is fastened to the supporting flange 3 and consists in this case of an upper intermediate plate 7 (according to FIGS. 8 and 9) and a lower supporting plate 8 (according to FIGS. 10 and 11). The number of plates is not critical: only one plate or even more than two plates can be used. The plate system 6 is carried by a plurality of spacers 9 distributed about the circumference, and corresponding screws (see FIG. 8). The lower supporting plate 8 is likewise held on the upper intermediate plate 7 by a plurality of spacers 10 distributed about the circumference, with corresponding screws (see also FIG. 10). The spacers 10 can be spacing pins, as shown, or can be in the form of sheet metal brackets.

Above the upper intermediate plate 7 there is a blower 11 and a heating element 12 with which heating is made possible in a cold environment to prevent water vapor condensation. Between the plates 7 and 8 a power transformer 13 is disposed. the number of contacts necessary for the electrical connections is omitted for the sake of simplicity, but it depends on the function and distribution of the electrical components. As a rule at least 6 terminal contacts are needed, including the contacts for the video signal.

On the bottom of the supporting plate 8 a commercial dome camera 14 is fastened, such as the ones supplied in similar form by various manufacturers. Such a dome camera includes a housing 15 to accommodate a number of electronic components and circuits. These also include two electric motors for the remote controlled rotation of a video camera about a vertical axis A and for swiveling the optical axis of this video camera about a second, horizontal axis in a vertical plane in which the axis A is located. The horizontal angle of rotation of the camera can be greater than 360°, the vertical swivel angle up to 100°, and the remote controlled operating speed is so great that this angle can be traversed in less than one second. In the case of automatic tracking of a moving target, this speed can also be much lower. Of course, the invention also includes dome cameras in which the optical axis of the lens together with the camera can be set manually.

With the optical axis of the video camera, combined movements can be continuously set and/or shifted below a plane in which the housing margin lies.

The housing 15 is closed at the bottom by a dome 16. In this dome 16 is a sector-shaped view window 17 behind which a lens 18 of a video camera, not shown in detail, is arranged. The dome 16, which has the shape of a hollow hemisphere, consists either wholly or partially of a material transparent to visible light and/or infrared radiation, which can also be tinted and/or silvered. The lens 18 can be an autofocus lens, a lens with a fixed focal length, with or without autofocusing, and/or a remote-controlled zoom lens. Further information is probably unnecessary, since such camera systems, also called dome cameras, are packaged for sale. The dome 16 can also consist of an opaque material in which the view window 17 is open, and in this case a transparent material can be placed in the view window in the form of a fitted sector of a spherical disk.

Significant for the following definitions is here a first plane of separation E1-E1 between the upper end of the housing 15 and the bottom of the lower supporting plate 8. Also important is the fact that, for this connection, neither an expensive bayonet coupling nor a guided plug-in connection with precisely arranged contacts are necessary as is the case with photographic cameras and even dome cameras, for which compatible protective housings are necessary anyway. A simple threaded connection and/or a plug connection and/or a soldered connection will suffice in the subject matter of the invention.

At the bottom of the supporting flange 3 is a protective housing 19 which consists of an upper hollow cylindrical housing jacket 20 and a second dome 21 attached to the bottom, which is at least substantially concentric with the first dome 16. Dome 21, which is likewise in the form of a hollow hemisphere, consists of a material transparent to visible light and/or infrared radiation, which can also be tinted and/or silvered. On its exterior the housing jacket 20 is surrounded by an additional jacket 22 which consists of thermal insulating and/or reflective material, but is not essential.

Between the upper edge of the housing jacket 20 and the outer margin of the supporting flange 3 an additional plane of separation E2-E2 is formed, i.e., after a plurality of screws 23 distributed on the circumference are removed, the protective housing 19 can be drawn down complete. Above the system thus far described a protective roof 24 is disposed which, after removal of screws 25, can be lifted upward. Thus the screws 23 are also accessible from the side. Alternatively, to avoid the need for disassembly of the protective roof 24, openings can be provided in its margin at the locations of the screws 23.

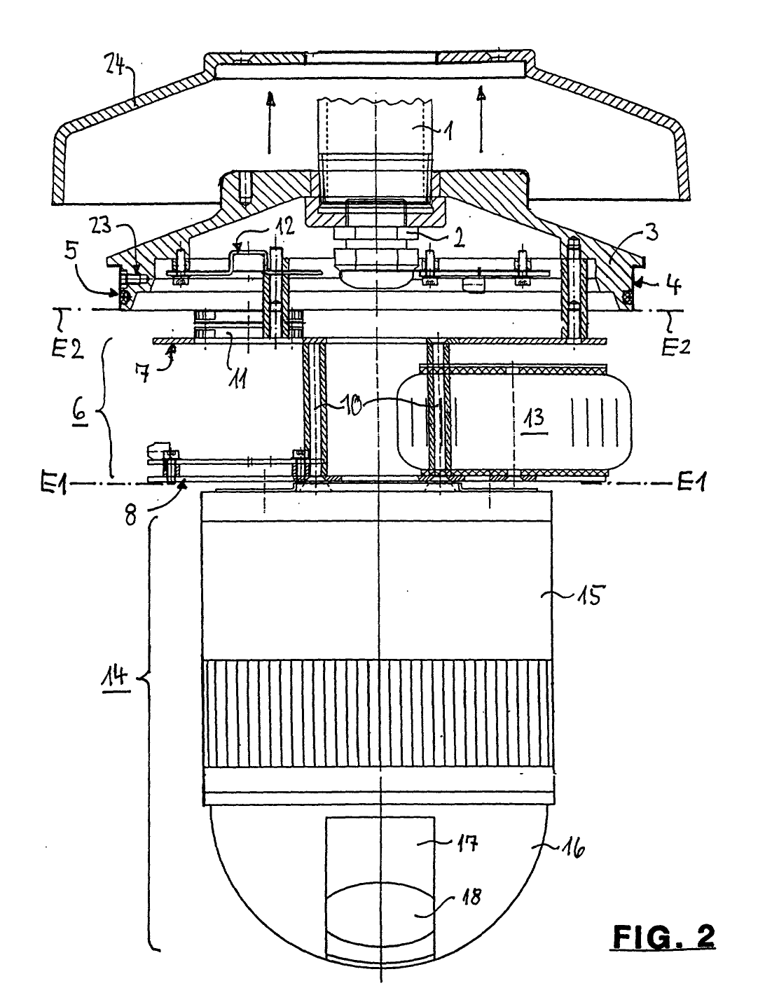

This condition is represented in FIG. 2. Since the plane of separation E2-E2 is above the plane of separation E1-E1 , the spaces above the plate 7 and between the plates 7 and 8 are accessible from the side and at an angle from the bottom for tool access, so that the mechanical and electrical connections and wiring as well as measurements can easily be carried out during assembly.

FIG. 3 shows the protective housing 19 as a dismounted assembly. The second or outer dome 21 is removably held on the bottom margin of the housing jacket 20 by an outwardly turned margin 26 between a ring 27 cemented, welded or integrally formed ring 27 and a snap ring 28. A round sealing ring 29 is provided as a gasket. At the upper margin the housing jacket 20 is provided with an enlargement 30 of its diameter and a step 31, so that the protective housing 19 can be fitted onto the cylindrical surface 4 of the supporting flange 3. After assembly of the parts according to FIGS. 2 and 3, the state shown in FIG. 1 is the result.

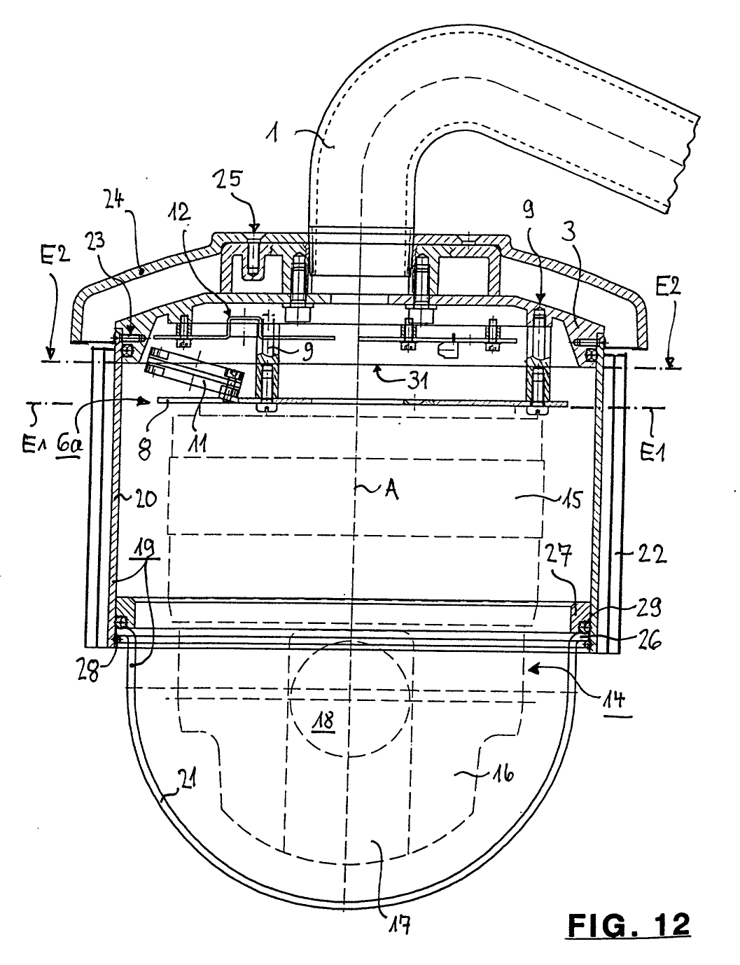

Important in this case is the following: The domes 16 and 21 (whether with or without the special view window 17) are to be at least largely concentric with one another and with the swiveling center and center of rotation of the video camera and its optical axis, respectively, in order to minimize optical distortion. This requires a defined length of the housing jacket 20. For example, when retrofitting an arrangement according to FIG. 1 to the one in FIG. 12, or vice versa, it may be necessary to replace the housing jacket 20 with a shorter or longer tubular section or to cut off part of the length of the tube section. The separability of the housing jacket 20 and dome 21 is an important requirement for this and for the replacement of a damaged dome. Alternatively, an adaptation is also possible by changing the length of the spacers 9 and/or 10.

Also, the expressions, “partially spherical” and “hemispherical” applied to the domes 16 and/or 21 are not necessarily restrictive geometrical descriptions. The partially spherical shells may very well also merge with cylindrical sections of the same diameter as that of the virtual margin, as is shown in FIG. 1, 3 and 12. It is also important—also in connection with the length of the housing jacket 20—that the bottom margin of non-transparent parts does not reach so far down that the range of rotation and swiveling of the lens 18 is undesirably shaded off from its angle of view.

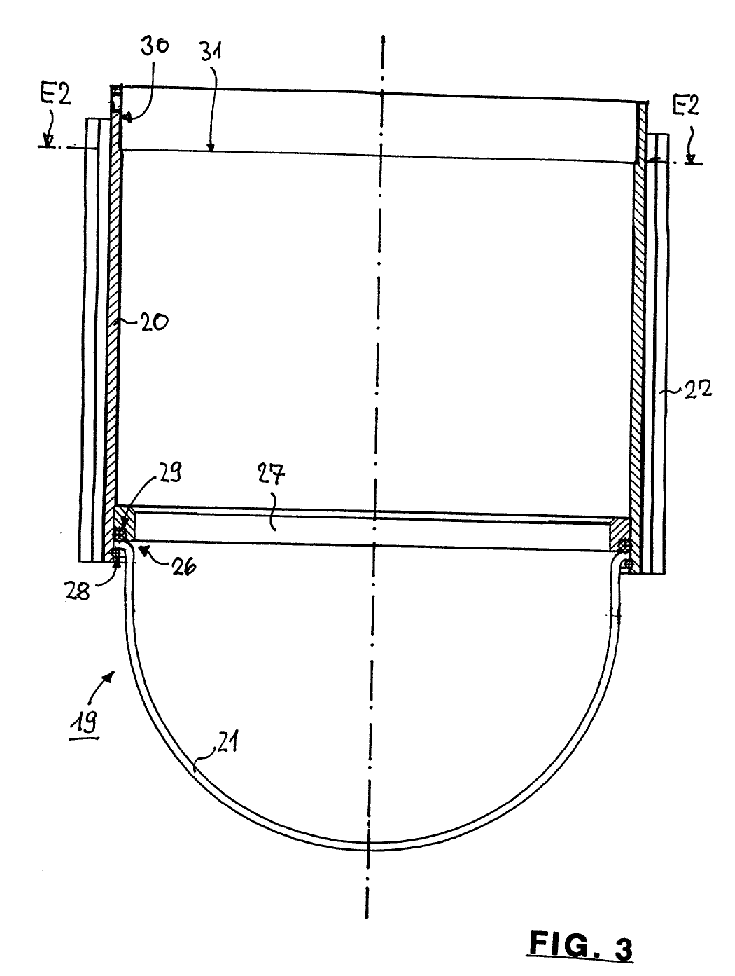

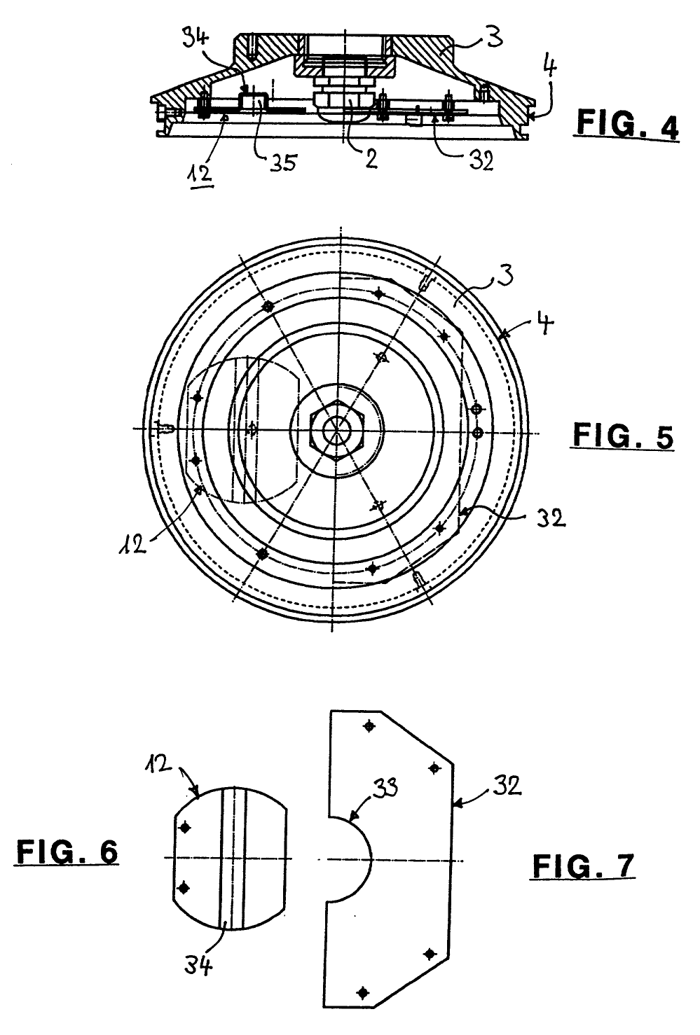

According to FIGS. 4 to 7, the heating element 12 and a trapezoid distributor plate 32 with a semicircular cutout 33 are screwed onto the supporting flange 3 from below (shown in broken lines in FIG. 5). The heating element 12 is configured as a sector of a circle in plan and has in its center a groove 34 in which a rod-like heater 35 is contained (FIG. 4). The terminals have been omitted for simplicity. By its arrangement above the blower 11 (FIGS. 1, 2 and 12) the circulated air is blown against the heating element and is thereby heated.

In FIGS. 8 and 9 the circular disk-shaped intermediate plate 7 is shown, which is screwed through the spacers 9 to the supporting flange 3 (FIG. 1 and 2). According to FIG. 9, this is done by means of keyhole-shaped openings 36 which can be pushed over the screw heads 37 (FIG. 8). After the intermediate plate 7 is rotated it can be tightened by the screw heads 37. At the margin of the intermediate plate 7 there are adjacent notches 38 for hanging a catching device, e.g., a loop, by which all of the removable parts are prevented from falling down. The blower 11 is fastened over an approximately square notch 38. Countersunk screw holes 39 serve for fastening the supporting plate 8 according to FIGS. 10 and 11.

According to FIGS. 10 and 11, in addition to the power transformer 13, an additional circuit board 40 is fastened on the supporting plate 8 and bears additional connecting means 41 of which one is represented on the outside left in FIG. 10. From a combined view of FIGS. 8 to 11 it can be seen that the entire plate system 6 can be removed downwardly by loosening the screw heads 37 and rotating the plate system 6 with or without the dome camera 14, and how the flexible connecting wires permit this, so that the accessibility of the plate system 6 is further improved, also from the top.

In FIG. 12, identical parts or parts serving the same purpose are provided with the same reference numbers. The plate system 6a in this case contains only a single supporting plate 8 for mounting the dome camera 14, which is indicated only by broken lines, and originates with another manufacturer. In this case no power transformer is present because the apparatus operates on low voltage, so that the housing jacket 20 of the protective housing 19 is shorter. In this case too, the plane of separation E2-E2 is above plane of separation E1-E1 so that, after the protective housing 19 is removed, the space above the supporting plate 8 is accessible from the side and from below at an angle for the introduction of tools to make and break mechanical and electrical connections. Otherwise, it is largely identical with the subject of FIGS. 1 to 3.

The construction according to FIGS. 4 to 11 can easily be transferred to the construction according to FIG. 12, the intermediate plate 7 being omitted and the supporting plate 8 performing its function of fastening the dome camera 14.

It is apparent from all figures that the entire system is made substantially rotationally symmetrical with the axis A-A, that the outside diameter of the protective housing 19 is as small as possible in proportion to the outside diameter of the dome camera 14, and that no manipulations are needed within the annular gap between the dome camera 14 and the protective housing 19 in order to make or break mechanical and/or electrical connections.

The dome camera 14 is removable as a unit from the inner dome 16 (with or without slot), from the video camera itself and from the installed housing 15.

I claim:

1. Video surveillance apparatus comprising:
a dome camera with a housing and an at least partially radiation-permeable first dome in which a video camera with a lens is disposed whose optical axis is adjustable about a vertical axis of rotation and a horizontal swivel axis, with
a plate system with electrical components and a mount for the dome camera a first plane of separation being disposed between the plate system and the dome camera and with
a protective housing which surrounds the plate system and the dome camera and which has a second radiation-permeable dome near the first dome wherein
the plate system is disposed on the bottom of a supporting flange and at least substantially below its outer margin,
the second dome is prolonged in the direction of the axis of rotation upward through a housing jacket which surrounds the plate system and has an upper margin which is releasably fastened to the supporting flange, a second plane of separation being formed at the junction point, and lies above the first plane of separation.

2. Video surveillance apparatus according to claim 1, wherein in the housing a rotary drive and a swiveling drive are disposed for the remote-controlled movement of the optical axis of the lens.

3. Video surveillance apparatus according to claim 1, wherein the supporting flange has a coaxial surface onto which the upper margin of the housing jacket can be placed.

4. Video surveillance apparatus according to claim 1, wherein the supporting flange is substantially discoidal in form and connects a mounting pipe to the housing jacket of the protective housing.

5. Video surveillance apparatus according to claim 1, wherein on the bottom of the supporting flange at least one supporting plate is fastened through at least one set of spacers and to it the dome camera is fastened, the first plane of separation being disposed between the supporting plate and the dome camera.

6. Video surveillance apparatus according to claim 5, wherein between the supporting flange and the supporting plate an intermediate plate is disposed, the intermediate plate being connected through a first set of spacers to the supporting flange and the supporting plate being connected through a second set of spacers to the intermediate plate.

7. Video surveillance apparatus according to claim 5, wherein the plate system is fastened removably as a component group to the supporting flange.

8. Video surveillance apparatus according to claim 6, wherein the plate system is fastened removably as a component group to the supporting flange.

9. Video surveillance apparatus according to claim 7, wherein the plate system is fastened by means of keyhole-shaped openings to the spacers of the supporting flange.

10. Video surveillance apparatus according to claim 8, wherein the plate system is fastened by means of keyhole-shaped openings to the spacers of the supporting flange.

11. Video surveillance apparatus according to claim 6, wherein a heating element is fastened to the supporting flange and a blower for circulating the heated internal atmosphere of the protective housing is fastened to the intermediate plate.

12. Video surveillance apparatus according to claim 5, wherein a heating element is fastened to the supporting flange and a blower for circulating the heated internal atmosphere of the protective housing is fastened to the supporting plate.

13. Video surveillance apparatus according to claim 1, wherein the housing jacket has a ring on its bottom, and that the second dome has an outwardly bent margin which is fixed against the ring by a snap ring with the interposition of a gasket.

14. Video surveillance apparatus according to claim 1, wherein the housing jacket is surrounded by an additional jacket.

15. Video surveillance apparatus according to claim 1, wherein above the supporting flange an upwardly removable protective roof is disposed, whose outer margin overlaps the upper margin of the protective housing.

16. Video surveillance apparatus according to claim 1, wherein the housing jacket of the protective housing is configured as a hollow cylinder.

17. Video surveillance apparatus according to claim 14, wherein the length of the housing jacket amounts to at least 0.5 times its outside diameter.

18. Video surveillance apparatus according to claim 15, wherein the length of the housing jacket is at least 0.8 times its outside diameter.

19. Video surveillance apparatus according to claim 1, wherein the outer dome consists of a partially spherical shell from whose margin a hollow cylindrical prolongation of the same diameter as that of the margin extends toward the housing jacket.

20. Video surveillance apparatus according to claim 17, wherein the outer dome consists of a hemispherical shell and of a hollow cylindrical prolongation of the same diameter.
